(19) United States
(12) Patent Application Publication
(10) Pub. No.: US 2007/0108269 A1
(43) Pub. Date: May 17, 2007

(54) Processing merchant point-of-sale transactions using a mobile subscriber device

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/280,550

(22) Filed: Nov. 16, 2005

(51) Int. Cl. G06K 5/00; G06Q 40/00

(52) U.S. Cl. 235/380; 705/44

(57) ABSTRACT

In an exemplary method, a telecommunication network node receives a communication originated by a wireless mobile device where the communication contains transaction information of items selected for purchases. The subscriber is authenticated as a member authorized to use purchase transaction services. A database stores an account of the subscriber. A debit to the account of the subscriber is generated and stored where the debit is for the purchase price of the items.

### BACKGROUND

This invention relates to the processing of purchases, and more specifically to using a mobile wireless device as an automated data collection device to obtain information related to the purchase of the product and debiting an account for the amount of the purchase.

Credit card transactions represent a substantial volume that continues to grow. In a typical transaction a user identifies the products to be purchased to the retail merchant. The identities of these items are entered into the retail merchant's point-of-sale (POS) station such as by barcode scanning. The user's credit card containing a magnetic strip with coded information about the user's account is then swiped through a reader at the retail POS station. The user's account information is transmitted from the POS station to a transaction database that validates the credit worthiness of the user's account, debits the amount of the transaction to the user's account, and returns the relevant information about the transaction to the originating POS station. The POS station concludes the transaction by generating a printed receipt for the user.

The user's credit account information can also be communicated to a retail POS station by other methods than reading the magnetic strip on a conventional credit card. Of course, a sales clerk can manually enter the user's credit card number into the POS station using a keypad. Wireless communication techniques have also been utilized to communicate the user's credit card information to a merchant POS station. For example, the Mobil “Speedpass” cylindrical wireless device typically attached to a key ring can wirelessly communicate the identity of a user's account as the device is passed in close proximity to a wireless receiver installed as part of the merchant POS station. However, after the user's account information has been input into the merchant POS station, the transaction is processed as a normal credit card transaction. With increased expectations of efficiency and flexibility by current users of mobile communication devices, e.g. cellular telephones, there exists a need for a more integrated approach to the processing of retail purchases in conjunction with wireless mobile devices.

### SUMMARY

It is an object of the present invention to satisfy this need.

In an exemplary method, a telecommunication network node receives a communication originated by a wireless mobile device where the communication contains transaction information of items selected for purchase. The subscriber is authenticated as a member authorized to use purchase transaction services. A database stores an account of the subscriber. A debit to the account of the subscriber is generated and stored where the debit is for the purchase price of the items.

In another exemplary method, a limited-area wireless communication link is established between a wireless mobile device of a subscriber and a POS system of a merchant from which items are sought to be purchased. The wireless mobile device receives from the merchant POS system over the limited-area wireless communication link transaction information including identity of items selected for purchase and corresponding prices, and identification of the merchant. Another wireless communication link is established between the wireless mobile device and a mobile switching center. The transaction information is transmitted over the another wireless communication link from the mobile device to a telecommunication node that has access to an account of the subscriber so that the account can be debited using the transaction information.

In a further exemplary method, a wireless mobile device acquires identities of items to be purchased. A limited-area wireless communication link is established between the wireless mobile device of a subscriber and a POS system of a merchant from which items are sought to be purchased. The wireless mobile device acquires the identities of items to be purchased without the assistance of the POS system. The wireless mobile device transmits to the merchant POS system over the limited-area wireless communication link at least the identities of items selected for purchase. The wireless mobile device receives from the merchant POS system over the limited-area wireless communication link the transaction information including prices of the items selected for purchase and identification of the merchant. Another wireless communication link is established between the wireless mobile device and a mobile switching center. The transaction information is transmitted over the another wireless communication link from the mobile device to a telecommunication node that has access to an account of the subscriber so that the account can be debited using the transaction information.

### DESCRIPTION OF THE DRAWINGS

Features of exemplary implementations of the invention will become apparent from the description, the claims, and the accompanying drawings in which:

FIG. 1 is a block diagram of an exemplary communication and processing system suited for processing retail transactions and debiting a user's account in accordance with illustrative methods of the present invention.

FIG. 2 is a block diagram of an embodiment of a mobile communication device in accordance with the present invention.

FIG. 3 is a flow chart illustrating steps in accordance with an exemplary method of the present invention.

### DETAILED DESCRIPTION

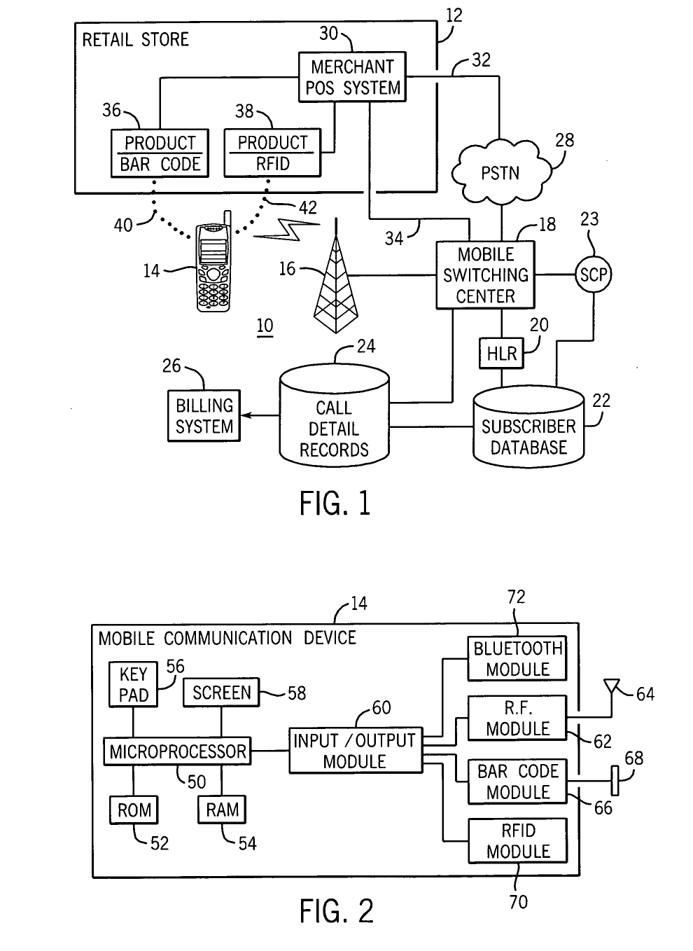

FIG. 1 shows an exemplary telecommunication system 10 that supports communications with an illustrative retail store 12. A wireless mobile device 14 is capable of wireless communications with a base station 16 and is supported by a mobile switching center (MSC) 18. The mobile device 14 as used herein means any portable communication device utilized by a wireless communication services subscriber for communications with others in the telecommunication network such as, but not limited to, a cellular telephone, wireless-enabled personal digital assistant (PDA), laptop computer with a wireless communication capability, etc. The MSC 18 is supported by a home location register (HLR) 20 which applies location and administrative functions associated with the wireless customers. A subscriber database 22 contains records and information related to the wireless customers and is cooperatively connected to HLR 20. An intelligent peripheral node 23 such as a service control point is coupled to the MSC 18 and subscriber database 22, and serves to terminate and originate transaction communications. A call detail records (CDR) database 24 is coupled to the MSC 18 and to the subscriber database 22. The CDR database 24 collects and stores call origination and termination information for use in connection with determining telecommunication charges incurred by customers for communication services provided. The information collected by CDR database 24 is periodically transferred to a billing system 26 that parses the information by subscriber in order to determine the amount to be charged to specific customers during a time interval such as monthly. The MSC 18 is also coupled to the public switched telephone network (PSTN) 28 that provides a gateway to a variety of telecommunication nodes.

The retail store 12 includes a merchant POS system 30 utilized to process purchase transactions. It is connected by communication paths 32 and 34 with the PSTN 28 and MSC 18, respectively. These paths permit data involved in a credit transaction to be transferred from and to the merchant POS system 30. An exemplary product 36 is identified with a conventional barcode that may be read by a barcode reader built into or connected with the merchant POS system 30. Another exemplary product 38 includes a radio frequency identification (RFID) tag that identifies each type of product, similar to use of a barcode, by utilizing wireless communications with an RFID receiver which may be built into or connected with the merchant the POS system 30.

The mobile device 14 includes the capability of directly obtaining the product identification information such as provided by a barcode or RFID tag as represented by dotted lines 40 and 42, respectively. For example, the mobile device 14 may include a barcode reader and/or an RFID receiver. Alternatively, the mobile device 14 may receive this information from the merchant POS system 30 such as by an optical communication link or a wireless communication link such as supported by Bluetooth protocol.

FIG. 2 illustrates an exemplary mobile communication device 14 that operates under the control of stored program instructions as executed by microprocessor 50. It is supported by read-only memory (ROM) 52 and random access memory (RAM) 54. Initial boot up instructions, applications and control data reside in the ROM 52. Part of this information will be typically written into RAM 54 during the ongoing operation and processing of instructions by microprocessor 50. One of the stored applications will provide support for the basic two-way wireless communications. Other applications support the processing of input data such as received from keypad 56 and the processing of output data to be displayed on screen 58. An input/output module 60 is coupled to and supports communications between microprocessor 50 and other peripheral modules such as RF module 62, barcode module 66, RFID module 70 and Bluetooth module 72. The RF module 62 is coupled to an antenna 64 which may be internal or external to the device 14. The RF module 62 includes an RF transmitter and receiver for transmitting and receiving information between the device 14 and a base station, as well as a modulator/demodulator and decoder that provides an interface between digital data utilized by the microprocessor 50 and analog RF signals transmitted over the wireless link. The barcode module 66 may comprise a built-in barcode scanner as part of device 14 or may comprise an interface module that accepts input from an external barcode scanner by plug 68. The RFID module 70 may comprise an RFID receiver that is part of the device 14. Similarly, the Bluetooth module 72 may comprise a Bluetooth transceiver module that is part of the device 14. Both Bluetooth and RFID communications represent different forms of a limited-area wireless communication protocol as opposed to a wireless communication technology such as cellular intended for general communication services over substantially larger geographical areas.

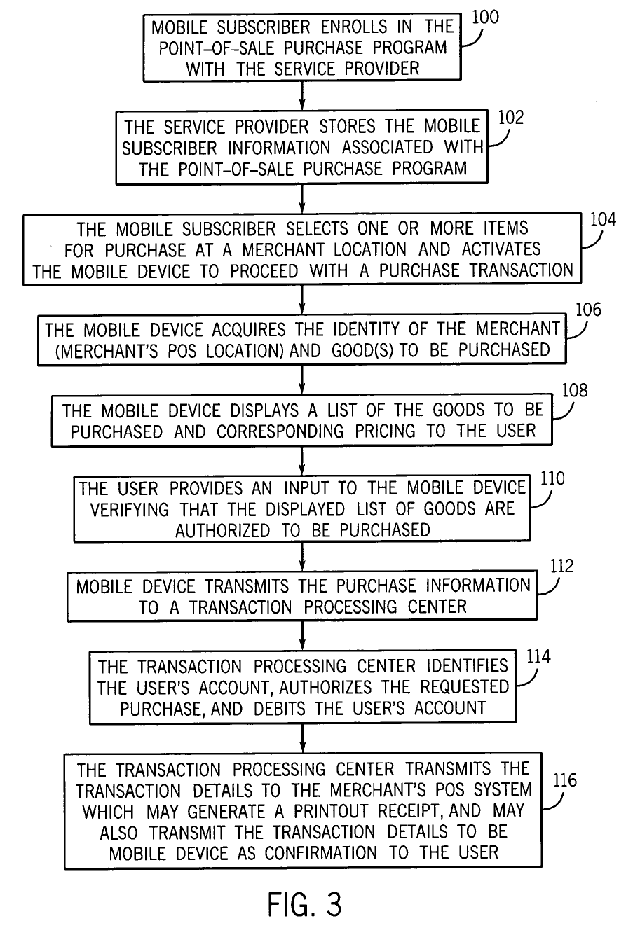

FIG. 3 shows an exemplary method for processing a POS credit transaction utilizing a mobile communication device in accordance with an embodiment of the present invention. In step 100 the user, mobile communication services subscriber, enrolls in a POS purchase program with the mobile communication service provider, e.g. a cellular service provider. The enrollment may include configuring the subscriber's mobile communication device 14 such as by downloading appropriate software from the subscriber's communication service provider or activating software resident on the mobile device. In step 102 a separate account may be established with or through the mobile communication service provider including the user's name, account number, amount of the account, spending limit, electronic serial number (ESN) of the mobile device, etc. This account may be stored in the consumer database 22. If the account is to be maintained by the mobile communication service provider, then the subscriber's normal account associated with the payment of communications services may also serve as the same account for accepting POS credit transactions. Alternatively, the mobile communication service provider may elect to serve as a front end processor of the requests for POS credit transactions and rely upon a conventional credit card processing system to manage the mobile subscriber's POS transaction account.

In step 104 the mobile subscriber selects one or more items for purchase at a merchant location and activates the mobile communication device to assist in processing the POS purchase transaction. The items may represent goods, services or combination thereof to be purchased. As used herein, “merchant location” refers to a conventional retail store or location at which the subscriber is present at the time of the subject transaction. The mobile communication device may be activated by pressing a predetermined button, key or combination of keys on a keypad of the device, activating a touch screen object such as on a personal digital assistant, highlighting or selecting information displayed on a screen, or entering a predetermined spoken command interpreted by speech recognition processing. Upon this activation, the mobile device acquires the identity of the merchant and/or the merchant's POS location, as well as the identity of the items to be purchased in step 106. The acquisition of this information may be accomplished in a variety of ways. This information may be acquired by a localized wireless communication between the Bluetooth module 72 of the mobile device 14 and a corresponding Bluetooth transceiver associated with the merchant's POS system 30. Alternatively, the RFID module 70 or barcode module 66 of the mobile device 14 could be utilized to directly access the identity of the items to be purchased. If a technique is utilized in which the mobile device 14 directly obtains the identity of the items to be purchased, the identity of the merchant can be acquired from a corresponding special RFID module encoded with the merchant's identity at the POS location or the identity of the merchant can be registered as a predetermined barcode that can be read. Alternatively, the identity of the merchant and/or the identities of the items could be manually entered into the mobile device by the user. In step 108 the mobile device displays a list of the items to be purchased and corresponding pricing to the user. If the purchase information was initially acquired by a Bluetooth or RFID communication, then the pricing information will have been included for each item. If the identity of the items was obtained by barcode scanning by the mobile device 14, then the mobile device 14 will transmit the identity of each item such as by Bluetooth communications to the merchant's POS system which will supply the pricing information to the mobile device by a return Bluetooth communication.

In step 110 the user provides an input to the mobile device 14 verifying that the displayed list of items are authorized to be purchased. This input may consist of a depressing a predetermined button, keypad or touch screen entry, etc. and may also include the entry of a password used to authenticate the user. Next in step 112 the mobile device transmits the purchase transaction information utilizing wide area RF communications with the base station 16 to the MSC 18. In order to provide security for the transmission of the transaction information, the information may be encrypted as a datagram such as by utilizing the ESN of the mobile as a key. In this illustrative example, the mobile communication services provider not only acts as a front end communication interface but also serves as a transaction account manager. In accordance with this example, the MSC 18 transmits the information by HLR 20 to the subscriber database 22 where the user's transaction account is maintained. A transaction data can be transmitted in a variety of ways. A predetermined telephone number stored in the mobile device 14 and associated with the subscriber database 22 can be used to terminate a call to the SCP 23 originated from the mobile device 14 with the transaction data being transmitted over the established call path. Alternatively, the mobile device 14 can utilize a data mode of communication with the SCP 23 associated with the subscriber database 22 having an assigned Internet address or telephone number to which the data communication mode is established.

In step 114 the transaction processing center, i.e. the subscriber database 22 in conjunction with call detail records database 24, identifies the user's account, authorizes the requested purchase and debits the user's account with the amount of the purchase. In this exemplary embodiment, the subscriber database 22 serves to identify and authenticate the user with regard to POS purchase transactions. Billing of the user's account may be accomplished by storing a corresponding record in the call detail records database 24. Thus, the items purchased will appear on the user's monthly account statements along with other telecommunication charges when the statement is issued by the telecommunication service provider. The billing system 26 periodically collects the information stored in the call detail records database 24 and processes this information into accumulated billing during the billing cycle.

In step 116 the transaction processing center transmits the transaction details to the merchant's POS system which may generate a printout receipt, and also may transmit the transaction details to the mobile device as confirmation directly to the user. The transaction details can be transmitted to the merchant's POS system in a variety of ways. A telephone call can be established by an intelligent peripheral node, SCP 23, associated with subscriber database 22 with a telephone number associated with the merchant's POS system wherein the transaction details are transmitted as data over the established call path. Alternatively, the SCP 23 can initiate a data mode communication with the merchant's POS system 30 that has an assigned Internet address or telephone number to which the data communication mode is established. The telephone number/address of the merchant POS system will have been acquired by the mobile device 14 as part of the transaction information and will preferably be included in the transaction information transmitted to the SCP 23 for the subscriber database 22.

Although exemplary implementations of the invention have been depicted and described herein, it will be apparent to those skilled in the art that various modifications, additions, substitutions, and the like can be made without departing from the spirit of the invention.

The scope of the invention is defined in the following claims.

We claim:

1. A method for processing a purchase transaction comprising the steps of:
receiving at a telecommunication network node a communication originated by a wireless mobile device where the communication contains transaction information including identity of items selected for purchase and corresponding prices, and identification of a merchant from which the items are to be bought and of a subscriber to pay for the items;
authenticating the subscriber as a member authorized to use purchase transaction services;
storing in a database an account of the subscriber;
generating and storing a debit to the account of the subscriber where the debit is for the purchase price of the items.

2. The method of claim 1 wherein the telecommunication network node that receives the communication containing the transaction information terminates a path of the communication originated by the wireless mobile device, the telecommunication network node being part of the wireless network infrastructure of a wireless communication services provider that supplies wireless communication services to the subscriber via the wireless mobile device.

3. The method of claim 1 wherein the generating and storing of the debit comprises the steps of generating and storing the debit in the account of the subscriber where the account is also utilized to store charges for telecommunication services as determined by the wireless communications services provider.

4. The method of claim 3 wherein the generating and storing of the debit further comprises the step of storing the debit as a call detail record entry in a call detail record database utilized by the wireless communication services provider.

5. The method of claim 1 further comprising the step of acquiring at least part of the transaction information by the wireless mobile device using a limited-area wireless communication protocol for communications between the wireless mobile device and a merchant point-of-sale system.

6. The method of claim 5 wherein the step of receiving the communication at the telecommunication network node comprises receiving the communication carried by a wide area wireless communication protocol.

7. The method of claim 1 further comprising the steps of transmitting from the telecommunication network node to a point-of-sale system of the merchant from which the items are being brought a communication containing purchase transaction details reflecting the debit to the subscriber's account.

8. A method for acquiring information about a purchase transaction comprising the steps of:
establishing a limited-area wireless communication link between a wireless mobile device of a subscriber and a point-of-sale (POS) system of a merchant from which items are sought to be purchased;
receiving, by the wireless mobile device from the merchant POS system over the limited-area wireless communication link, transaction information including identity of items selected for purchase and corresponding prices, and identification of the merchant;
establishing another wireless communication link between the wireless mobile device and a mobile switching center;
transmitting the transaction information over the another wireless communication link from the mobile device to a telecommunication node that has access to an account of the subscriber so that the account can be debited using the transaction information.

9. The method of claim 8 wherein the telecommunication network node that receives the transaction information terminates the another wireless communication link, the telecommunication network node being part of the wireless network infrastructure of a wireless communication services provider that supplies wireless communication services to the subscriber via the wireless mobile device.

10. The method of claim 8 further comprising the steps of generating and storing the debit in the account of the subscriber where the account is also utilized to store charges for telecommunication services as determined by a wireless communications services provider of the subscriber.

11. The method of claim 10 wherein the generating and storing of the debit further comprises the step of storing the debit as a call detail record entry in a call detail record database utilized by the wireless communication services provider.

12. The method of claim 8 further comprising the steps of transmitting from the telecommunication network node to the POS system of the merchant a communication containing purchase transaction details reflecting the debit to the subscriber's account.

13. A method for acquiring information about a purchase transaction comprising the steps of:
acquiring by a wireless mobile device identities of items to be purchased;
establishing a limited-area wireless communication link between the wireless mobile device of a subscriber and a point-of-sale (POS) system of a merchant from which items are sought to be purchased, the wireless mobile device acquiring the identities of items to be purchased without the assistance of the POS system;
transmitting, by the wireless mobile device to the merchant POS system over the limited-area wireless communication link, at least the identities of items selected for purchase;
receiving, by the wireless mobile device from the merchant POS system over the limited-area wireless communication link, transaction information including prices of the items selected for purchase and identification of the merchant;
establishing another wireless communication link between the wireless mobile device and a mobile switching center;
transmitting the transaction information over the another wireless communication link from the mobile device to a telecommunication node that has access to an account of the subscriber so that the account can be debited using the transaction information.

14. The method of claim 13 wherein the telecommunication network node that receives the transaction information terminates the another wireless communication link, the telecommunication network node being part of the wireless network infrastructure of a wireless communication services provider that supplies wireless communication services to the subscriber via the wireless mobile device.

15. The method of claim 13 further comprising the steps of generating and storing the debit in the account of the subscriber where the account is also utilized to store charges for telecommunication services as determined by a wireless communications services provider of the subscriber.

16. The method of claim 15 wherein the generating and storing of the debit further comprises the step of storing the debit as a call detail record entry in a call detail record database utilized by the wireless communication services provider.

17. The method of claim 13 further comprising the steps of transmitting from the telecommunication network node to the POS system of the merchant a communication containing purchase transaction details reflecting the debit to the subscriber's account.

18. The method of claim 8 further comprising the steps of displaying on a screen of the mobile device the identities and corresponding prices of the items sought to be purchased, and receiving an input initiated by the subscriber by the mobile device where the input defines whether or not the subscriber agrees to purchase the displayed items at the displayed prices.

19. The method of claim 18 further comprising the step of receiving by the mobile device a password entered by the subscriber where entry of a predetermined password establishes authority to enter into the purchase transaction.
